(19) United States
(12) Patent Application Publication
(10) Pub. No.: US 2003/0034215 A1
(43) Pub. Date: Feb. 20, 2003

(54) Extension structure of swivel wheel

(76) Inventor: Jeng Dar Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/930,292

(22) Filed: Aug. 16, 2001

(51) Int. Cl. B62D 33/08; B62D 21/14

(52) U.S. Cl. 190/18 R; 280/37; 190/18 A

(57) ABSTRACT

The present invention provides an extension structure of a swivel wheel, which comprises a base seat and an extension rod. The base seat has a guide groove defined by a bottom face and two sidewalls. The front end of the bottom face has a projective stop block. The two sidewalls have lock grooves at the front and rear ends thereof. The extension rod has a guide rod matched and sleeved into the guide groove. The bottom of the guide rod has a groove to let the stop block abut thereon timely. Two sides at the rear end of the guide rod have tenons capable of being locked in the lock grooves timely. The swivel wheel at the front end of the extension rod can extend out a predetermined distance to obtain an extended supporting point, thereby preventing a traveling suitcase from falling down because of an unstable center of gravity.

### FIELD OF THE INVENTION

The present invention relates to an extension structure of a swivel wheel and, more particularly, to a novel structure capable of preventing a traveling suitcase from falling down because of an unstable center of gravity.

### BACKGROUND OF THE INVENTION

In the present busy society, going out traveling has become the best recreation to relax spirits and to free from pressure for most people. During longtime and long-distance travels, traveling suitcases are inevitable equipments. Personal needments, clothes, and articles or documents can be placed in the receiving space thereof. Moreover, articles purchased during the journey can be received therein. Traveling suitcases are most widely used when going abroad traveling because it takes longer time and thus articles and documents to be taken along increase relatively. However, a traveling suitcase cannot receive too many articles. Therefore, a traveling suitcase with a receiving space extended forwards has been proposed. Or a bag is directly hung at the front end of a traveling suitcase for receiving more articles.

As shown in FIG. 1, a general traveling suitcase 1a comprises a box 10a, a pull rod 11a, and a fixed caster set 12a. The pull rod 11a is fixedly disposed at the back of the box 10a for pulling the traveling suitcase 1a. The fixed caster set 12a is locked at two sides of the rear end of the bottom of the box 10a to facilitate the motion of the traveling suitcase 1a. Additionally, a foot pad 13a is pivotally disposed at either side of the front end of the bottom of the box 10a to form a support structure so that the box 1a can keep a stationary state when the traveling suitcase 1a is at rest.

However, the foot pads 13a of the above traveling suitcase 1a form a fixed support structure. If more articles are placed in the traveling suitcase with a receiving space extended forwards, or a bag is hung at the front end of the traveling suitcase, an imbalance force will be generated because the center of gravity moves to the front end when the traveling suitcase is at rest. Therefore, the traveling suitcase will fall down to spoil the articles therein. Accordingly, the above traveling suitcase has inconvenience and drawbacks in practical use. The present invention aims to resolve the above problems in the prior art.

### SUMMARY OF THE INVENTION

The primary object of the present invention is to provide an extension structure of a swivel wheel, whereby a swivel wheel at the front end of an extension rod extends outwards a predetermined length to obtain an extended supporting point, thereby achieving the object of balance and stability.

The secondary object of the present invention is to provide an extension structure of a swivel wheel, which can be disposed at the bottom of a traveling suitcase to let the traveling suitcase have supporting points of four swivel wheels. When the swivel wheel extends, the transporting and receiving functions of the traveling suitcase will not be affected. Moreover, the extension structure can be adjusted according to different widths of traveling suitcases.

To achieve the above objects, the present invention provides an extension structure of a swivel wheel, which comprises a base seat and an extension rod. The base seat has a guide groove. A panel in the guide groove has a projective stop block. Panels at two sides of the guide groove respectively have lock grooves at the front and rear ends thereof. Moreover, the extension rod has a guide rod matched and sleeved into the guide groove. The surface of the guide rod has a groove so that the stop block can abut thereon timely. Two sides at the rear end of the guide rod respectively have tenons capable of being locked in the lock grooves timely. The front end of the extension rod is locked with a swivel wheel. The extension rod can protrude out of the base seat to obtain an extended supporting point, thereby preventing a traveling suitcase from falling down because of an unstable center of gravity.

The various objects and advantages of the present invention will be more readily understood from the following detailed description when read in conjunction with the appended drawing, in which:

### BRIEF DESCRIPTION OF THE DRAWINGS

FIG. 1 is a perspective view of a prior art traveling suitcase;

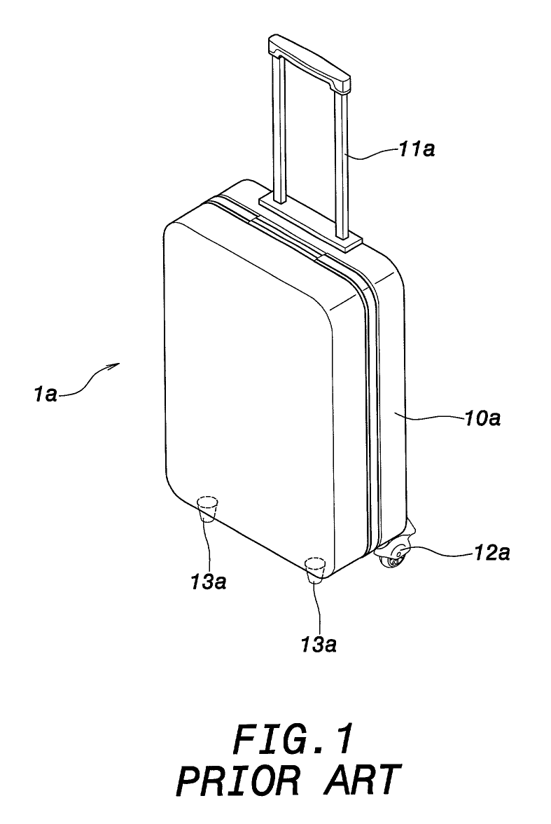

FIG. 2 is an exploded perspective view of an extension structure of a swivel wheel of the present invention;

FIG. 3 is a perspective view of the present invention when the extension structure does not extend out;

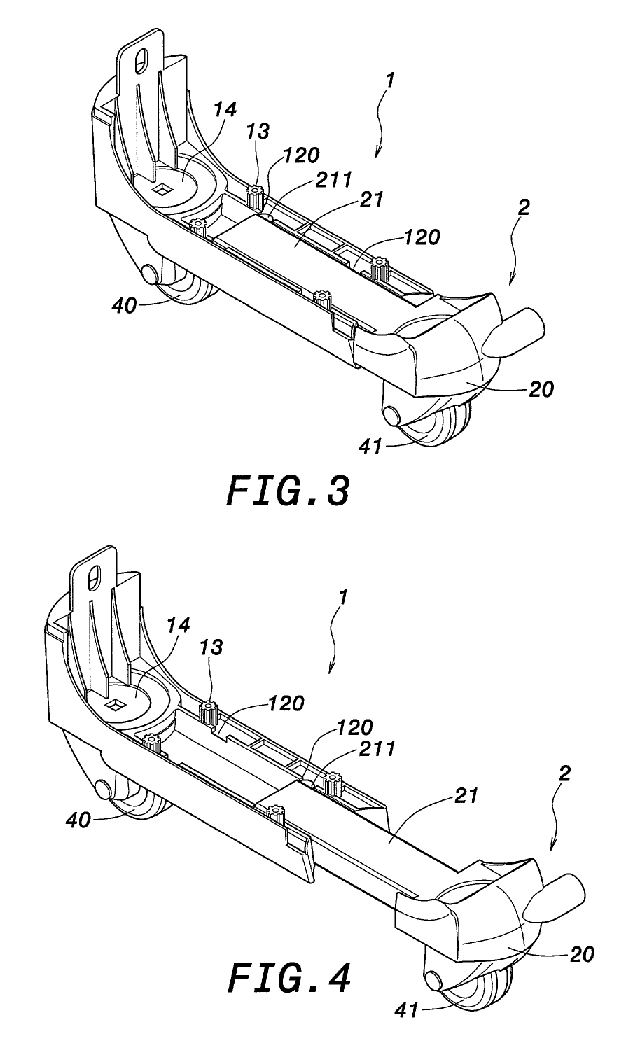

FIG. 4 is a perspective view of the present invention when the extension structure extends out;

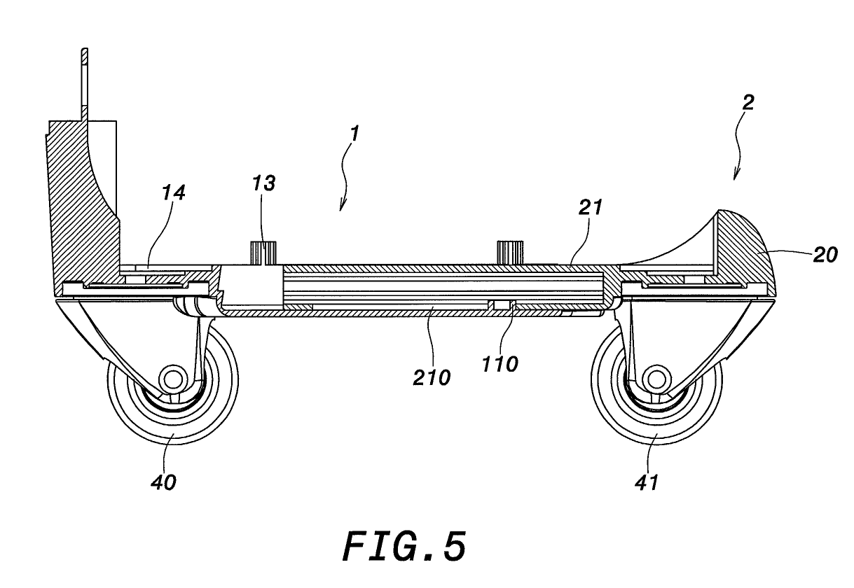

FIG. 5 is a side cross-sectional view of the present invention when the extension structure does not extend out;

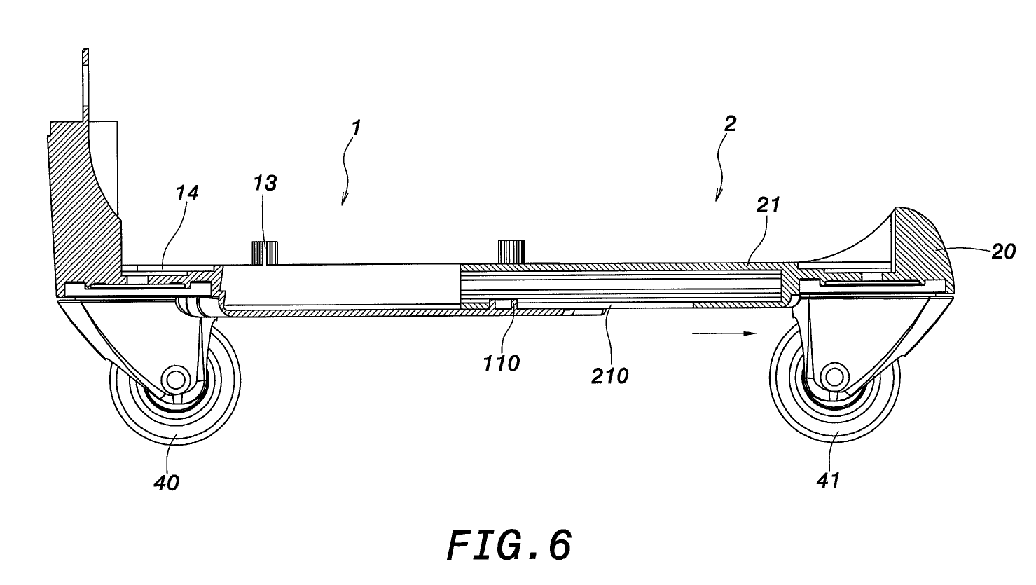

FIG. 6 is a side cross-sectional view of the present invention when the extension structure extends out;

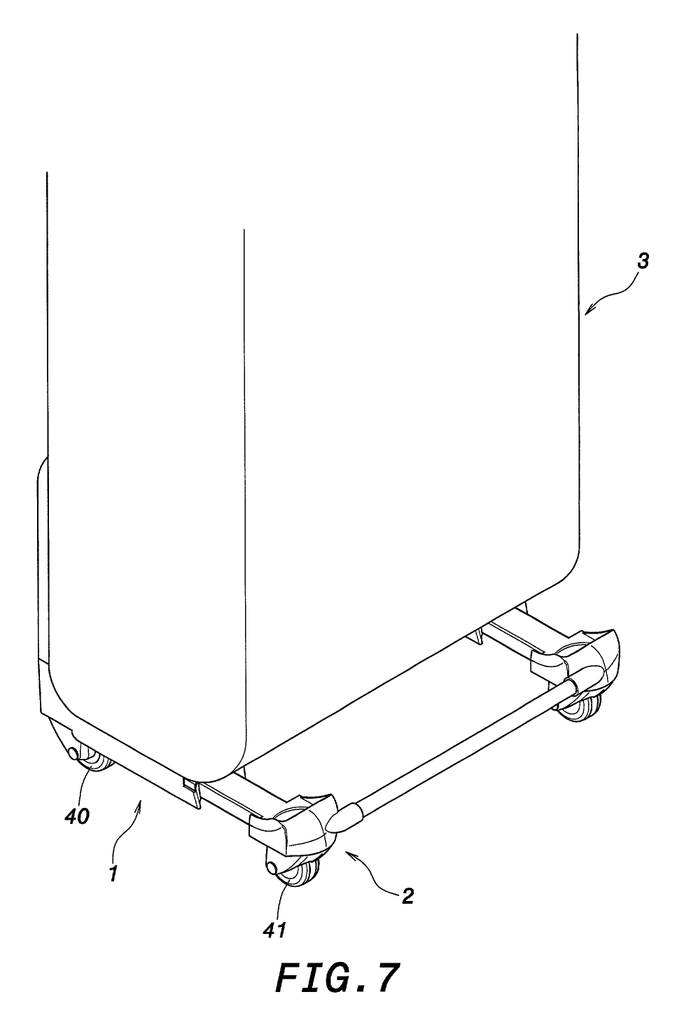

FIG. 7 is a side view of the use state of the present invention; and

FIG. 8 is a front view of the use state of the present invention.

### DETAILED DESCRIPTION OF THE PREFERRED EMBODIMENTS

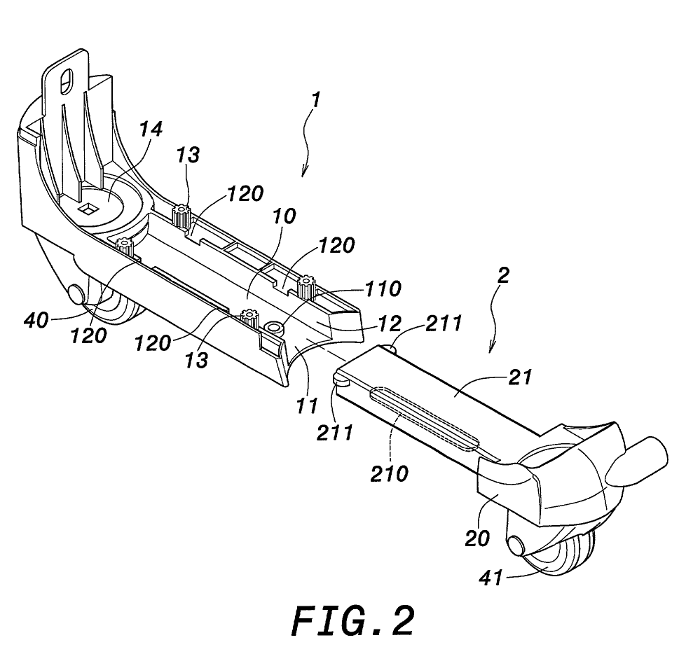

As shown in FIG. 2, an extension structure of a swivel wheel of the present invention comprises a base seat 1 and an extension rod 2.

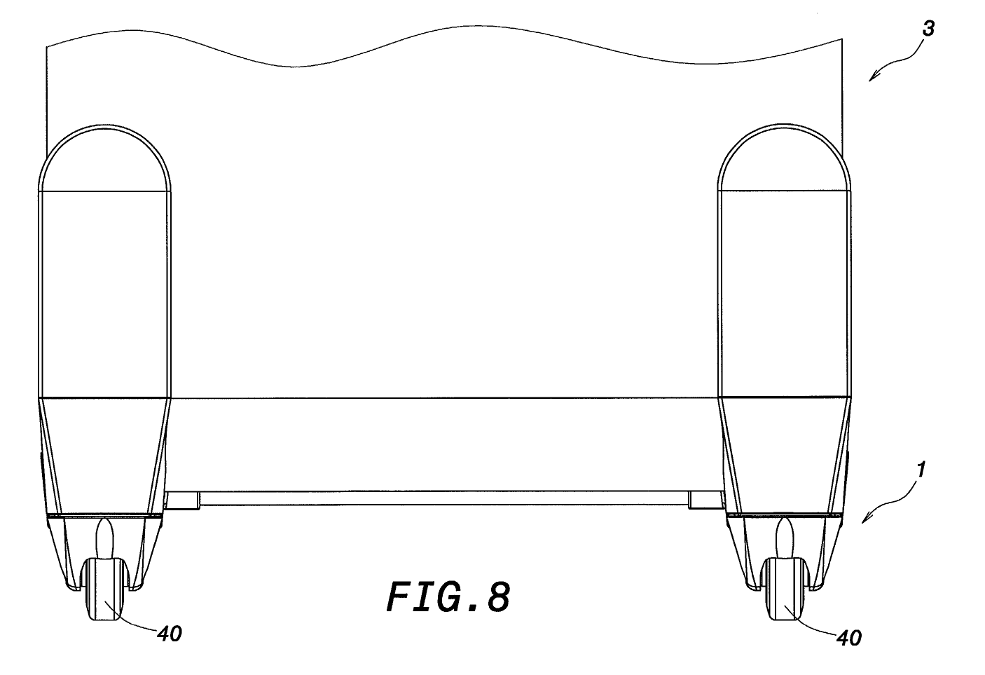

The base seat 1 has a proper profile to be fitly disposed at the bottom of a traveling suitcase 3, as shown in FIG. 7. The base seat 1 has a lengthwise guide groove 10 to let the extension rod 2 be suitably sleeved thereinto. The guide groove 10 is defined by a bottom face 11 and two sidewalls 12. The front end of the bottom face 11 has a projective stop block 110. The two side walls 12 respectively have lock grooves 120 formed at upper edges of the front and rear ends thereof. A plurality of locking parts 13 capable of being locked at the bottom of the traveling suitcase 3 are disposed at predetermined positions of the base 1. The rear end of the base 1 has a fixed caster portion 14, which can be locked with a swivel wheel 40 to be supported on the ground.

The front end of the extension rod 2 has a fixed caster portion 20, which can be locked with a swivel wheel 41 to be supported on the ground. The rear end of the fixed caster portion 20 adjoins a guide rod 21. The guide rod 21 can be slidably matched in the guide groove 10 of the base seat 1. The bottom of the guide rod 21 has a lengthwise groove 210, which can cover on the stop block 11 of the base seat 1. The stop block 11 can abut against the front and rear walls of the groove 210 timely to let the extension rod 2 move restrainedly within a certain distance. Moreover, two sides of the rear end of the guide rod 21 respectively have arcuate tenons 211 at the upper edges thereof. The arcuate tenons 211 can be timely locked in the lock grooves 120 at the front or rear end of the base seat 1 to let the extension rod 2 be located at a certain position after extending out or being folded.

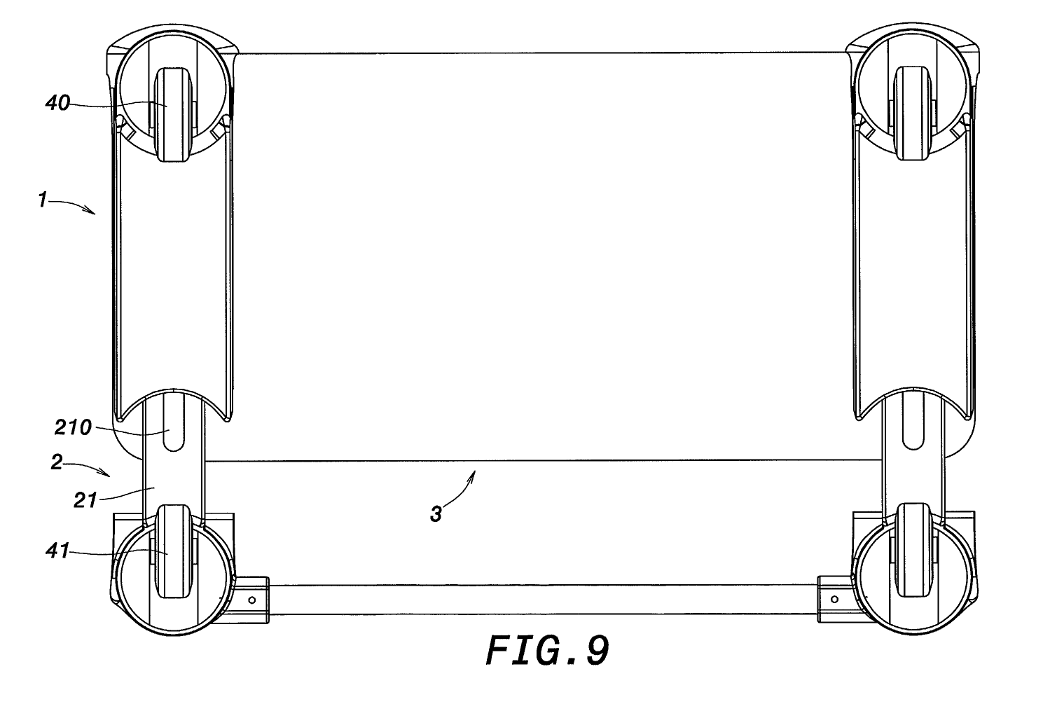

Thereby, the extension structure of a swivel wheel of the present invention can be locked onto a traveling suitcase with a receiving space extended forwards, or be locked onto a traveling suitcase with a bag hung at the front end thereof, as shown in FIGS. 7 and 8. Before being used, the guide rod 21 of the extension rod 2 is fixedly sleeved into the guide groove 10 of the base seat 1 so that the stop block 110 of the base seat 1 abuts against the front wall of the groove 210 of the extension rod 2, and the arcuate tenon 211 of the extension rod 2 is locked in the lock groove 120 at the rear end of the base seat 1.

If the extension rod 2 is to extend out from the base seat 1, a proper force is exerted to let the arcuate tenon 211 detach from the lock groove 120 at the rear end of the base seat 1. Because of the guidance of the arcuate tenon 211, the guide rod 21 of the extension rod 2 will slide forwards in the guide groove 10 until the stop block 110 of the base seat 1 abuts against the rear wall of the groove 210 of the extension rod 2. The arcuate tenon 211 of the extension rod 2 will simultaneously be locked in the lock groove 120 at the front end of the base seat 1 to be located at a specific position. At this time, the guide rod 21 of the extension rod 2 extends out from the base seat 1 to let the swivel wheel 41 at the front end of the extension rod 2 extend outwards a predetermined length to obtain an extended supporting point. Therefore, the traveling suitcase 3 can achieve the object of balance and stability.

Additionally, when the traveling suitcase 3 bears heavier articles, the level face of the bottom of the traveling suitcase will deform. Therefore, the bottom face 11 in the guide groove 10 can be designed to form an upward slanting angle of 0˜15 degrees so that the guide rod 21 of the extension rod 2 can be retractably slide in the guide groove 10 of the base seat 1 along the slanting angle.

To sum up, the present invention is characterized in that a swivel wheel at the front end of an extension rod extends outwards a predetermined length to obtain an extended supporting point, thereby preventing a traveling suitcase from falling down because of an unstable center of gravity.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An extension structure of a swivel wheel, comprising:
a base seat having a guide groove, a panel of said guide groove having a projective stop block, panels at two sides of said guide groove respectively having lock grooves at the front and rear ends thereof; and
an extension rod having a guide rod matched and sleeved into said guide groove, the surface of said guide rod having a groove to let said stop block abut thereon timely, two sides of the rear end of said guide rod respectively having tenons capable of being locked in said lock grooves timely, the front end of said extension rod being locked with a swivel wheel to obtain an extended supporting point.

2. The extension structure of a swivel wheel as claimed in claim 1, wherein the base seat has a plurality of locking parts capable of being locked onto the bottom of a traveling suitcase.

3. The extension structure of a swivel wheel as claimed in claim 1, wherein the rear end of said base seat is locked with a swivel wheel.

4. The extension structure of a swivel wheel as claimed in claim 1, wherein the bottom face in said guide groove forms a slanting angle of 0˜15 degrees.

5. The extension structure of a swivel wheel as claimed in claim 1, wherein said tenon of said extension rod is arcuate.
